(19) United States
(12) Patent Application Publication
(10) Pub. No.: US 2012/0183685 A1
(43) Pub. Date: Jul. 19, 2012

(54) APPARATUS AND METHOD FOR DEPOSITING PARTICLES

(75) Inventor: David P. Aschenbeck, Newark, OH (US)

(73) Assignee: OWENS CORNING INTELLECTUAL CAPITAL, LLC, Toledo, OH (US)

(21) Appl. No.: 13/005,564

(22) Filed: Jan. 13, 2011

(51) Int. Cl. B05D 1/12

(52) U.S. Cl. 427/187; 118/308

(57) ABSTRACT

A granule applicator for an apparatus and method for applying granules onto an asphalt-coated sheet moving in a machine direction with improved resolution and edge definition of the applied granule patches and blends. One embodiment includes a rotating drum having openings that connect the interior space and an exterior of the rotating member. A granule dispenser is mounted within the interior space of the drum for dispensing granules there. A belt wraps around a major portion of the outside of the drum leaving an uncovered area. As the drum rotates within the belt, the granule openings move between a position closed by the belt and retaining granules by centripetal force and an open position wherein the granules are flung from the drum to a substrate. Doors may be used instead of a belt.

### TECHNICAL FIELD

This invention relates to applying or depositing particulates in a predetermined pattern on a tacky substrate. More particularly, this invention relates to methods and apparatus for controlling the deposition of granules from a granule applicator onto an asphalt-coated sheet.

### BACKGROUND OF THE INVENTION

Asphalt-based roofing materials, such as roofing shingles, roll roofing and commercial roofing, are installed on the roofs of buildings to provide protection from the elements and to give the roof an aesthetically pleasing look. Typically, the roofing material is constructed of a substrate such as a glass fiber mat or an organic felt, an asphalt coating on the substrate, and a protective and/or decorative surface layer of granules of stone, mineral, sand or other particulate material is embedded in the tacky asphalt coating.

A general process for manufacturing roofing shingles is described herein and U.S. Pat. Nos. 4,478,869; 6,095,082; 6,582,760; 6,610,147; and 7,163,716 are generally representative of these processes, and are incorporated herein in their entirety.

Three types of particulates or granules are typically employed in shingle manufacture. Headlap granules are granules of relatively low cost and are used for the portion of the shingle which will be covered up when installed on the roof. Prime granules are relatively more costly and are applied to the portion of the shingle that will be visibly exposed on the roof. They provide protection against the elements, particularly UV radiation, fire resistance and an aesthetically pleasing look. Both headlap and prime granules are generally used on the upper or top surface of a shingle. A third particulate, typically sand or other inexpensive granules, is coated on the under surface to facilitate handling and durability. The process of dropping, depositing or applying particulates or granules onto discrete areas or patches of the surface of a tacky substrate is generically referred to herein as “granule drop”; and the resulting area of granules on the substrate is also called a “granule drop.” Architects and consumers have demanded more decorative shingles and many different shades and patterns of shingle granules have been developed, leading to specific types of granule drops, as disclosed herein.

To provide a particular shade or color pattern, the exposed portion of the shingles may be provided with areas of different colors. Usually the shingles have a background color and a series of granule deposits of different colors or different shades of the background color. A common method for manufacturing the shingles is to dispense blends of granules of one or more color onto spaced areas of the tacky, asphalt-coated sheet. Background granules, optionally of a different shade or color, are then discharged onto the sheet and adhere to the tacky, asphalt-coated areas of the sheet between the granule deposits formed by the granule drops. The term “blend drop,” as used herein, refers to such a granule drop (process or resulting area) of different colors or different shades of color (with respect to the background color) that is discharged from a granule blend drop applicator onto the asphalt-coated sheet. Such blend drops may create regular patterns or irregular and random-like deposits on the shingle.

As is well known in the art, blend drops are often made up of granules of several different colors. For example, one particular blend drop that is supposed to simulate a weathered wood appearance might actually consist of some brown granules, some dark gray granules, and some light gray granules. When these granules are mixed together and applied to the sheet as a blend drop in a generally uniformly mixed manner, the overall appearance of weathered wood is achieved. Also, blend drops of darker and lighter shades of the same color, such as, for example, dark gray and light gray, are referred to as different color blends rather than merely different shades of one color. For this reason, blend drops may be a single shade or color, or mixtures of colors or shades or colors, and may also be referred to as a color blend.

Other times it may be desirable to create “faux” designs or textures using different colors of granules, as described in U.S. Pat. No. 6,511,704. As examples, one may achieve the look of a tabbed shingle by the use of regularly-spaced, short lines of darker color; or may approximate the look of a layered or laminated shingle through the use of such “shadow” lines and patches. Granule drops of this nature tend to be thin “lines” or patches, and are referred to herein as “shadow drops” or “shadow lines.” A special case of a shadow drop may be used with true, tabbed shingles. Tabbed shingles have cutout slots along one edge to create the tabs, and the cutout areas expose a portion of the upper or headlap area of the shingle. For protective and aesthetic reasons, this area may also be covered with prime granules, as taught in U.S. Pat. No. 1,795,913. A way to save cost is to use prime granules only in the areas of the headlap that are exposed by the tab cutouts of the overlying shingle (see FIG. 2). A regular, repeating shadow drop can accomplish this. Shadow drops tend to be a single color, but may also be a mixture of colors.

One of the problems with conventional granule application equipment is that, while it may be acceptable at low line speeds (e.g. 300-500 feet/minute), it tends to produce poor resolution or “sheet smear” at higher line speeds. Usually the granules are fed from a hopper by means of a fluted roll from which, upon rotation, the granules are discharged onto the sheet. The roll is ordinarily driven by a servo motor or a drive motor intermittently engaged by a brake-clutch mechanism. The ability to dispense granules onto a shingle in a precise location and with a precise pattern is hampered by both resolution and timing or synchronization problems. As shingle manufacturing line speed increases, both of these problems are accentuated so as to be serious limitations on the kinds of patterns and color contrasts that can be applied to shingles at high production speeds with conventional granule drop technology.

A known granule depositing method designed to overcome the sharpness problem of conventional granule applicators is shown in U.S. Pat. No. 5,795,389 issued to Koschitzky. The Koschitzky reference discloses an auxiliary belt onto which a series of patches of granules is deposited. The auxiliary belt is positioned above the asphalt-coated sheet, and includes an upper flight and a lower flight, with the upper flight travelling in a direction opposite that of the asphalt-coated sheet. At the upstream end of the auxiliary belt (i.e., upstream with respect to the movement of the asphalt-coated sheet) the upper flight of the auxiliary belt turns around a belt roller to form the lower flight. A retaining conveyor is wrapped around the upstream end of the auxiliary conveyor to keep the granules from flying about as the granules are turned into a downward direction. The granules of each of the patches are dropped vertically straight down onto the asphalt-coated sheet to form blend drops. The Koschitzky patent also discloses that a shroud, instead of a retaining conveyor, can be used to direct the granules into a downwardly directed vertical stream of granules.

While the retaining conveyor disclosed in the Koschitzky patent is able to successfully turn down the granules from the auxiliary conveyor, as the vertically moving granules make impact with the moving asphalt-coated sheet, a significant portion of the granules bounces on the sheet, landing downstream and thereby causing smeared of fuzzy blend drop edges rather than sharply defined leading and trailing edges for the blend drop. This problem is magnified to unacceptability when the asphalt-coated sheet is operated at high speeds.

U.S. Pat. No. 6,440,216 to Aschenbeck, employs a blend drop conveyor belt to advance granules toward the asphalt-coated sheet. In one embodiment (FIGS. 6-7), granules are dispensed vertically onto a vertical section of a curved belt, and they smoothly follow the travel of the belt until the belt curves under release roller 104, when they fall to the substrate. The belt is held to a curved shape by a pair of spaced-apart drums and the granules flow on the belt between these drums without interference from the drums. The velocity of the granules is controlled by raising or lowering the granule dispenser relative to the belt.

U.S. Pat. No. 6,582,760 to Aschenbeck, employs a blend drop conveyor belt to advance granules toward the asphalt-coated sheet. Preferably the conveyor is inclined at about 30 degrees relative to the plane of the sheet, imparting both a vertical and horizontal component of velocity to the granules. Pockets or chambers in the belt collect granules and accelerate them to a second speed for application to the sheet.

U.S. Pat. No. 5,814,369 to Bockh et al. and U.S. Pat. No. 5,997,644 to Zickell, each discloses a granule applicator having an applicator roll positioned to rotate directly above a moving asphalt-coated sheet. Granules corresponding to a desired blend drop are deposited onto the applicator roll at the top of the rotation, and when the applicator roll rotates approximately 180 degrees the blend drop falls off onto the asphalt-coated sheet when the blend drop reaches the bottom of the rotation. A media retaining belt engages the applicator roll, contacting and wrapping around the applicator roll to hold the blend drop granules on the surface of the applicator roll until the applicator roll rotates about 180 degrees. While this solution works at low line speeds, at higher speeds centrifugal force is sufficient to dislodge the granular media from the pockets before it can be entrained by the retaining belt.

Still, the problem of granule bounce, particularly at high sheet feed speeds, and the resultant inability to produce fine resolution and edge definition remain problems associated with these methods.

### SUMMARY OF THE INVENTION

Broadly, the present invention encompasses an apparatus and method for applying particles onto a sheet of tacky substrate moving in a machine direction at a sheet speed. In one aspect, an apparatus comprises: a rotatable member having an axis of rotation and an annular body wall defining an outer circumferential surface, at least one interior space and an exterior, the body wall having at least one circumferential opening connecting the interior space with the exterior; a particle dispenser mounted within the interior space of the rotating member and connected to a source of particles and adapted to dispense particles into the interior space; and an occlusion mechanism cooperating with said rotating member for occluding said circumferential opening when the circumferential opening is rotated to at least one first position, and when the circumferential opening is rotated to a second position, said occlusion mechanism uncovers the opening; wherein, as the rotatable member rotates about its axis of rotation, the circumferential opening rotates between said first portion, at which the belt closes the opening to the exterior, and said second portion wherein the opening is uncovered; wherein the apparatus is disposed relative to the moving sheet of tacky substrate such that, upon rotation, when the opening rotates to the second, uncovered portion the particles escape the opening and are deposited onto the tacky substrate.

The occlusion mechanism may be an arcuate band that wraps around a portion of the drum leaving an uncovered portion or segment, such as a belt; or it may be a door having one or more panels that cooperate to close the opening in its first position and open it in its second position.

The particles may be, for example, granules being applied to an asphalt-coated sheet for the manufacture of roofing shingles, as described in detail herein. The uncovered portion of the drum may comprise from about 30 to 90 degrees, more likely from about 45 to 70 degrees. The drum wall may have 1-8 openings, more likely 2-5 each being from about 0.25 to about 1.5 inches in width, depending on the application. The drum may have internal ribs or baffles for containing or directing the particles to the openings. The belt, when used, may be situated around an upstream roller positioned relative to the drum and sheet such that the particles enter the uncovered portion and traject tangentially toward the sheet at an angle from 5 to 35 degrees, preferably at a low angle of from about 15 to about 25 degrees. The drum may be divided axially into separate chambers for creating multiple lanes of patches on a sheet

In another aspect, the invention comprises a method of applying particles onto a sheet of tacky substrate using the apparatus described above, the method generally comprising: positioning said apparatus above a sheet of tacky substrate; introducing particles into the interior space of the rotatable member; and rotating the rotatable member to move said circumferential opening from its first, closed position to its second, open position at a speed sufficient to traject said particles onto the moving tacky substrate.

In some embodiments, the method comprises introducing particles into an interior space of a rotatable member having an axis of rotation and an annular body wall defining an outer circumferential surface, at least one interior space and an exterior, the body wall having at least one circumferential opening connecting the interior space with the exterior; rotatably engaging a first portion of the outer circumferential surface of the body wall of the rotating member with a belt, while a second portion remains uncovered by said belt; rotating the rotatable member whereby the circumferential opening rotates between said first portion, where centrifugal and gravitational forces cause the particles introduced into the interior space of the body to collect in the opening constrained by said belt, and said second portion, where the belt no longer constrains the particles, thereby releasing the particles outwardly from the rotating member; and disposing the rotating member to deposit the released particles onto the moving tacky substrate.

The method may be practiced using any of the variations of the embodiment discussed above, in particular for applying roofing granules onto asphalt-coated sheets. The particles may be released and deposited on the tacky substrate at “near sheet speed” for best effect. Advantageously, the patches produced on the tacky substrate have good edge and spatial resolution at slow speeds and equally good resolution at higher sheet speeds. The method may involve calculating a speed factor adjustment for drum diameters that are, for practical reasons, near but not identical to the desired diameter.

Other advantages of the granule applicator will become apparent to those skilled in the art from the following detailed description, when read in light of the accompanying drawings.

### BRIEF DESCRIPTION OF THE DRAWINGS

FIG. 1 is a schematic view in elevation of an apparatus for manufacturing an asphalt-based roofing material according to the invention.

FIG. 2 is an exploded plan view of two overlapping exemplary shingles manufactured with the apparatus illustrated in FIG. 1.

FIG. 3 is an enlarged schematic plan view of a portion of an asphalt-coated sheet resulting from a first embodiment of the granule applicator illustrated in FIGS. 1 and 5.

FIG. 4 is an enlarged schematic plan view of a portion of an asphalt-coated sheet resulting from a second embodiment of the granule applicator illustrated in FIGS. 1 and 7.

FIG. 5 is an enlarged cross sectional schematic view in elevation of the granule applicator illustrated in FIG. 1 at 22.

FIG. 6 is a perspective schematic view of a second embodiment of the granule applicator illustrated in FIG. 5.

FIG. 7 is an enlarged cross sectional schematic view in elevation of the granule applicator illustrated in FIG. 1 at 122.

### DETAILED DESCRIPTION OF THE INVENTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All references cited herein, including published or corresponding U.S. or foreign patent applications, issued U.S. or foreign patents, or any other references, are each incorporated by reference in their entireties, including all data, tables, figures, and text presented in the cited references. In the drawings, the thickness of the lines, layers, and regions may be exaggerated for clarity.

Unless otherwise indicated, all numbers expressing ranges of magnitudes, such as angular degrees or sheet speeds, quantities of ingredients, properties such as molecular weight, reaction conditions, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements. All numerical ranges are understood to include all possible incremental sub-ranges within the outer boundaries of the range. Thus, a range of 30 to 90 degrees discloses, for example, 35 to 50 degrees, 45 to 85 degrees, and 40 to 80 degrees, etc.

The term “particles” means any particulate matter. A specific example of particles is the roofing “granules” described herein, whether stone, mineral, glass, sand or other material. The term “tacky substrate” mans any medium that is, inherently or by coating applied to the medium, sticky or tacky and capable of receiving particles and holding them in or on the tacky substrate. A specific embodiment of a tacky substrate is the asphalt-coated mat or sheet described herein.

The term “asphalt coating” or “asphalt-coated” refers to any type of bituminous material suitable for use on a roofing material, such as asphalts, tars, pitches, or mixtures thereof. The asphalt can be either manufactured asphalt produced by refining petroleum or naturally occurring asphalt. The asphalt coating can include various additives and/or modifiers, such as inorganic fillers or mineral stabilizers, organic materials such as polymers, recycled streams, or ground tire rubber. Preferably, the asphalt coating contains asphalt and an inorganic filler or mineral stabilizer.

As used herein regarding patches of granules applied to a moving asphalt-coated sheet, the phrase “good spatial resolution” means that the sharp definition of the edges of the granule packet is retained and minimal distortion of the shape of each granule packet or blend drop occurs between its release from the belt and its contact with the asphalt-coated sheet. The granule packets retain their shape, relative spacing, and experience minimum splatter upon impact with the asphalt-coated sheet at a wide range of sheet speeds, e.g. from about 300 feet/minute to about 900 feet/minute, or higher.

### General Process

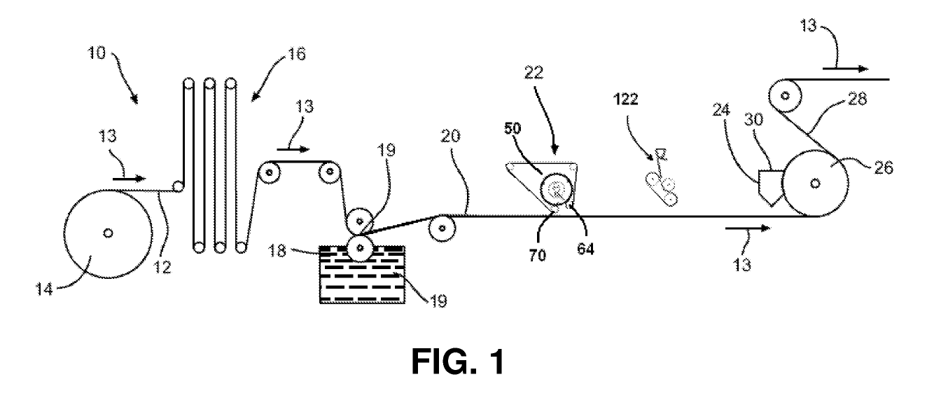

Composite shingles, such as asphalt shingles, are a commonly used roofing product. Referring to FIG. 1, asphalt shingle production generally includes feeding a base material or mat 12 from an upstream roll 14 and coating it first with a roofing asphalt material 19, then with one or more layers of granules 22, 122, 24. The base material is typically made from a fiberglass mat provided in a continuous shingle membrane or sheet. It should be understood that the base material can be any suitable support material.

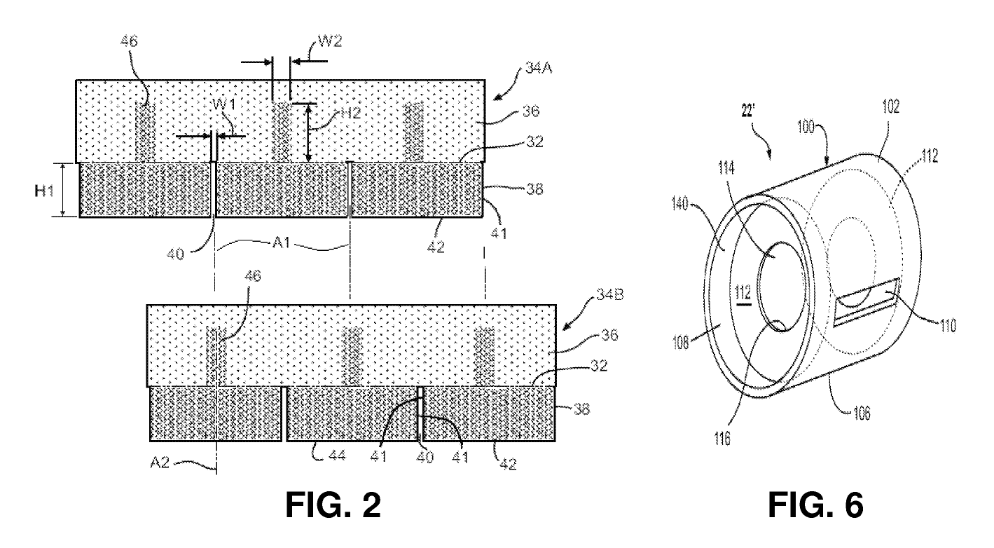

As shown in FIG. 2, composite shingles may have a headlap region or portion 36 and a prime region or portion 38. The headlap region may be ultimately covered by subsequent courses of shingles when installed upon a roof. The prime region will ultimately be visible when the shingles are installed.

The granules deposited on the composite material shield the roofing asphalt material from direct sunlight, offer resistance to fire, and provide texture and color to the shingle. Three main types of granules are previously described herein.

Referring again to FIG. 1 an apparatus 10 is shown for manufacturing an asphalt-based roofing material, and more particularly for applying granules onto an asphalt-coated sheet. The illustrated manufacturing process involves passing a continuous sheet of substrate or shingle mat 12 in a machine direction 13 through a series of manufacturing operations. The sheet usually moves at a speed of at least about 200 feet/minute (61 meters/minute), and typically at a speed within the range of between about 450 feet/minute (137 meters/minute) and about 800 feet/minute (244 meters/minute). However, other speeds may be used. Importantly, the sheet speed may vary even during a production run, requiring granule drop equipment that can operate at a wide range of sheet speeds without losing synchronization and while maintaining good spatial resolution.

In a first step of the manufacturing process, the continuous sheet of shingle mat 12 is payed out from a roll 14. The shingle mat 12 may be any type known for use in reinforcing asphalt-based roofing materials, such as a nonwoven web of glass fibers. Alternatively, the substrate may be a scrim or felt of fibrous materials such as mineral fibers, cellulose fibers, rag fibers, mixtures of mineral and synthetic fibers, or the like.

The sheet of shingle mat 12 is passed from the roll 14 through an accumulator 16. The accumulator 16 allows time for splicing one roll 14 of substrate to another, during which time the shingle mat 12 within the accumulator 16 is fed to the manufacturing process so that the splicing does not interrupt manufacturing.

Next, the shingle mat 12 is passed through a coater 18 where a coating of asphalt 19 is applied to the shingle mat 12 to form an asphalt-coated sheet 20. The asphalt coating 19 may be applied in any suitable manner. In the illustrated embodiment, the shingle mat 12 contacts a supply of hot, melted asphalt 19 to completely cover the shingle mat 12 with a tacky coating of asphalt 19. However, in other embodiments, the asphalt coating 19 could be sprayed on, rolled on, or applied to the shingle mat 12 by other means. Typically the asphalt coating is highly filled with a ground mineral filler material, amounting to at least about 60 percent by weight of the asphalt/filler combination. The asphalt coating 19 is typically in a range from about 350° F. to about 400° F., but may be more than 400° F. or less than 350° F. The shingle mat 12 exits the coater 18 as an asphalt-coated sheet 20. The asphalt coating 19 on the asphalt-coated sheet 20 remains hot throughout a portion of the manufacturing process so as to remain a tacky substrate for particle deposition.

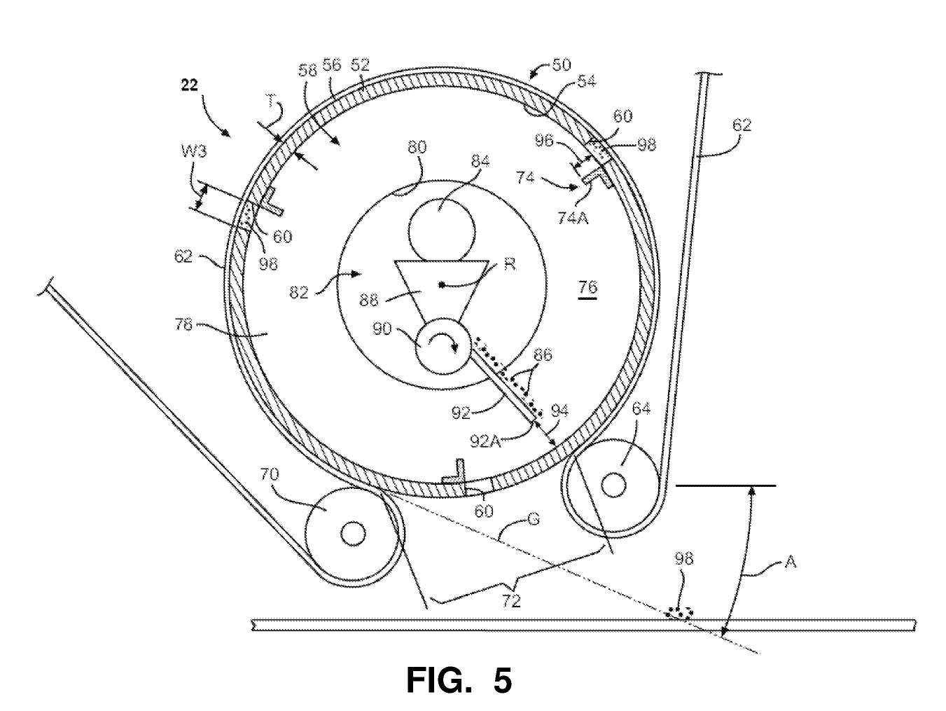

While tacky, the asphalt-coated sheet 20 is passed beneath a first granule applicator 22 where granules are applied to the asphalt-coated sheet 20. The granule applicator 22 may be a blend drop or shadow drop type, or any other type. Although only one granule drop applicator 22 is shown, it will be understood that several granule drop applicators 22 may be used in series (even of same types). Also, the granule drop applicator 122 may be adapted to supply several streams of granules of different colors, shading, or size via a manifold assembly (not shown). A particular embodiment of a shadow drop applicator is illustrated in FIGS. 1 and 5 and is described below.

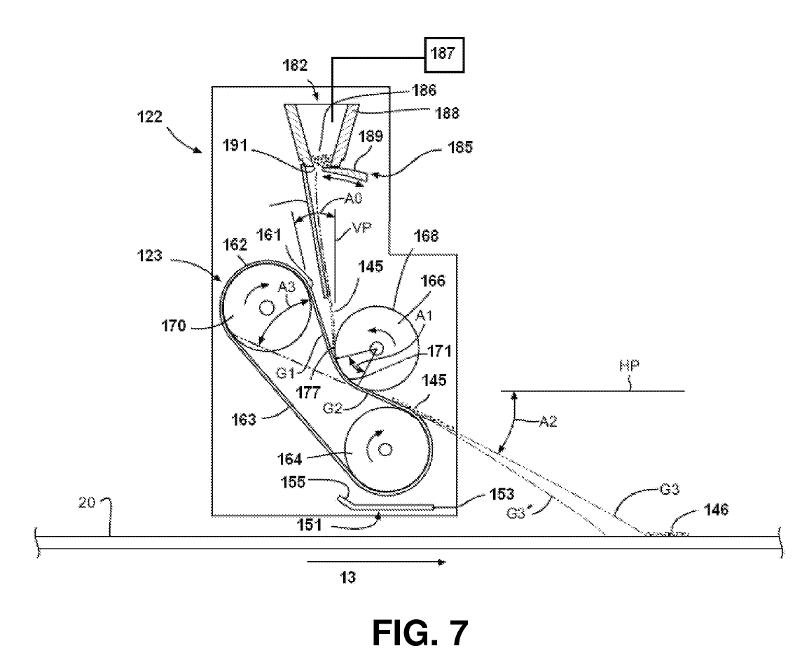

The asphalt-coated sheet 20 is then passed beneath a second granule applicator 122, which also may be a blend drop or shadow drop type, or any other type. Although only one granule drop applicator 122 is shown, it will be understood that several granule drop applicators 122 may be used in series. Also, the granule drop applicator 122 may be adapted to supply several streams of granules of different colors, shading, or size via a manifold assembly (not shown). A particular embodiment of a blend drop applicator is illustrated in FIGS. 1 and 7 and is described below.

The asphalt-coated sheet 20 is then passed beneath a third granule applicator 24. In the illustrated embodiment, the third granule applicator is a curtain granule applicator 24, for applying background granules (not shown) onto the asphalt-coated sheet 20. The background granules adhere to the portions of the asphalt-coated sheet 20 that are not already covered by the previously dropped granules. The background granules are applied to the extent that the asphalt-coated sheet 20 becomes completely covered with granules, thereby defining a granule-coated sheet 28. The granule-coated sheet 28 is then turned around a slate drum 26 to press the granules into the asphalt coating and to temporarily invert the sheet 28. While the sheet 28 is inverted, sand or other third particulate substance may be coated on the reverse side of sheet 28. The inverting also causes any excess granules to drop off the granule-coated sheet 28 on the backside of the slate drum 26. The excess granules are collected by a backfall hopper 30 of the background granule applicator 24 as is shown in U.S. Pat. No. 4,478,869. The granule-coated sheet 28 is then cooled, cut and packaged in any suitable manner, not shown. The cooling, cutting and packaging operations are well known in the art.

Although the various granule drop applicators described herein may be used in any order, it is typically the case that prime granules are applied prior to headlap granules, since headlap granules are applied by a curtain dispenser to the entire sheet area and stick where granules are not already present. The granule drop applicators of the present invention are generally used to apply prime granules. If both shadow drop and blend drop applicators are used in a single line, it may be preferable to apply shadow drop patches prior to blend drops.

During operation of the apparatus 10, the moving asphalt-coated sheet 20 may break. When such a break occurs, a portion of the asphalt-coated sheet 20 may whip or travel upwardly and into the granule applicators. To prevent damage to the granule applicators, a protective plate may be installed between the sheet 20 and the dispensing apparatus of granule applicators. Such a protective plate is shown in FIG. 7 in connection with a blend drop applicator 122, described in detail below. A protector plate 151 may be mounted below a downstream roller 164, and generally has an elongated body 153 having a length corresponding to width of the belt 162. The protector plate body 153 may be substantially flat having a second upturned portion 155 at its leading or upstream edge.

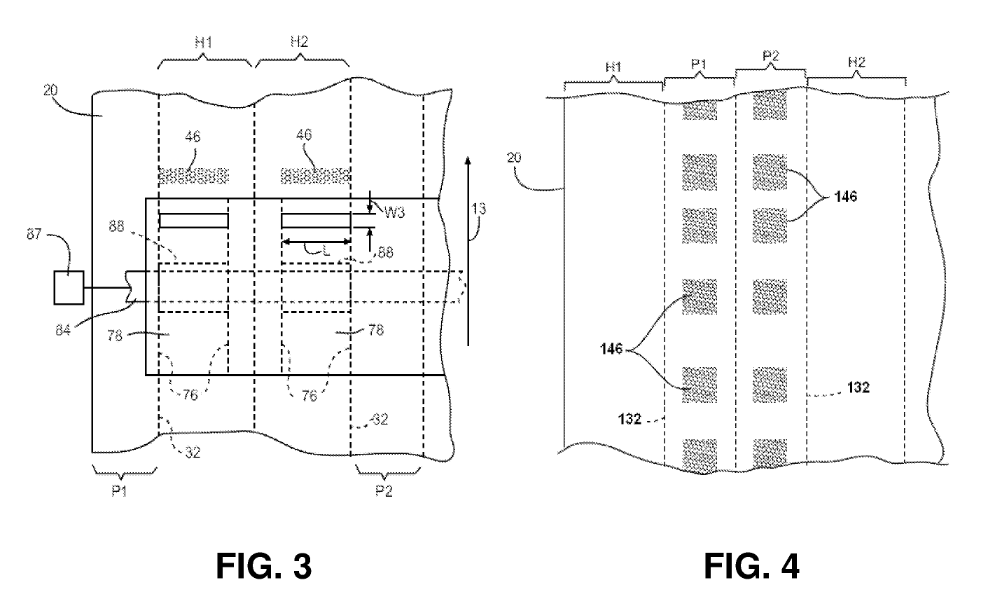

A portion of an exemplary asphalt-coated sheet 20 is shown in FIGS. 3 and 4. As shown, the asphalt-coated sheet 20 may be used in an apparatus 10 for forming multiple shingles. For example, the asphalt-coated sheet 20 may be used in an apparatus 10 for forming a plurality of shingles, such as two, three, or four shingles. The background granules may include granules of different colors, sizes and/or types. In a four-wide apparatus, the asphalt-coated sheet 20 includes eight different lanes, only four of which are illustrated. In the embodiments of the asphalt-coated sheets 20 illustrated in FIGS. 3 and 4, two headlap granule lanes H1 and H2, and two prime granule lanes P1 and P2 are shown in each. In FIG. 3, the two headlap regions, H1 and H2, are shown adjacent one another in the central area; while in FIG. 4, the two prime regions, P1 and P2, are shown adjacent one another in the central area of the four lanes shown.

An imaginary interface line 32, 132 extends in the machine direction 13 and defines a boundary between two granule lanes having a different color and/or type of granule. In the illustrated embodiments, the interface line 32, 132 is defined between adjacent headlap granule lanes and prime granule lanes, such as between the headlap granule lane H1 and the prime granule lane P1.

Exemplary roofing shingles that may be formed from the asphalt-coated sheet 20 are shown at 34A and 34B in FIG. 2. The shingles 34A and 34B may be cut from the asphalt-coated sheet 20 as shown in FIG. 3. Each shingle 34A and 34B would be cut from one headlap granule lane H1 or H2, and one respective adjacent prime granule lane P1 or P2. Accordingly, the shingles 34A and 34B includes a headlap portion 36 comprising headlap granules, and an exposed prime or portion 38 comprising prime granules.

### Centrifugal ‘Shadow Drop’ Applicator

In the embodiment of FIG. 2, the shingles are the tabbed type. The prime portion 38 of the illustrated shingles 34A and 34B includes a plurality of cutouts 40, which define a plurality of tabs 42 having spaced-apart side edges 41. The cutouts 40 extend from a lower edge 44 of the butt portion 38 substantially to the interface line 32 and define a height H1 and a width W1. In accordance with the methods described herein, a plurality of granule shadow areas or patches 46 are applied to the headlap portion 36. The granule patches 46 are substantially rectangular in shape and have a height H2 and a width W2. The width W2 of the granule patch 46 is larger than the width W1 of the cutout 40. The height H2 of the granule patch 46 is also larger than the height H1 of the cutout 40. In the illustrated embodiment, the granule patch 46 has a width W2 of about 1.0 inch and a height H2 of about 5.5 inches. Alternatively, the granule patch 46 may have any other desired dimensions, although this embodiment is best suited for applying lines, bars, strips or bands having relatively narrow width (W2) dimensions of about 0.5 inch to about 1.5 inches.

In the illustrated embodiment, the granule patches 46 are darker in appearance than a portion of a remainder 48 of the headlap portion 36, which may be covered with background granules of a relatively light color. Also, the granule patches 46 may be the same or darker in appearance and color than the prime portion 38.

In general, when installed on a roof deck, roofing shingles are arranged in a series of overlapping horizontal courses. In FIG. 2, the shingles 34A and 34B represent portions of such overlapping courses. The shingles of each course are offset to prevent the joint which is formed between each adjacent shingles in each course from corresponding to the joint between adjacent shingles in the subsequent overlapping course. Without such an offset, water from precipitation would inevitably penetrate these joints and find its way to potentially damage the underlying roof deck.

As shown in FIG. 2, each cutout 40 defines an axis A1 (vertically oriented upon installation), and each granule patch 46 defines axis A2, substantially parallel to axis A1. The shingles are thus offset such that each axis A1 of the cutout 40 is aligned with an axis A2 of the granule patch 46. Such an alignment of the axes A1 and A2 ensures that the granule patch 46 and the cutout 40 are aligned such that the darker granules of the granule patch 46 are visible through the cutout 40 when installed on a roof, such as when the shingle 34A is installed over the shingle 34B. This provides an aesthetic benefit as well as a protective benefit.

Referring now to FIG. 5, a first embodiment of the first granule applicator 22 is shown. The first granule applicator 22 includes a rotating member or drum 50 having an axis of rotation R and a substantially cylindrical wall defining a body 52. The body 52 includes an interior surface 54 and an outer circumferential surface 56. The interior surface 54 of the body 52 defines an interior space 58. At least one and preferably a plurality of granule outlet openings 60 are formed through the body 52. The illustrated body 52 has a thickness T of about 0.25 inches. Unless otherwise stated, the dimensions mentioned herein are not critical, though they may be preferred.

The illustrated drum 50 has a diameter of about 12 inches. Alternatively, the drum 50 may have any other diameter, such as a diameter within the range of from about 6 inches to about 30 inches. The drum 50 may have any desired length, such as a length substantially equal to the width of the asphalt-coated sheet 20, as implied in FIG. 3. The illustrated drum 50 further has three granule outlet openings 60 circumferentially spaced 120 degrees apart, although other configurations are possible as discussed below.

Each granule outlet opening 60 defines a granule slot having an axially-aligned length L and a circumferentially-aligned width W3 corresponding, respectively, to the desired height H2 and width W2 of the granule patch 46 to be deposited on the asphalt-coated sheet 20. For example, the illustrated granule outlet opening 60 has a width W3 of about 1.0 inch and a length L of about 5.0 inches. Alternatively, the granule patch 46 may have any other desired dimensions.

The granule opening 60 also has a depth corresponding to the thickness T of the body 52. An occlusion mechanism, described below, defines a radially outward, bottom surface of the granule openings 60. The drum 50 is rotatably mounted in a frame (not shown) and may be rotated directly or indirectly by a motor (not shown), preferably synchronized with the sheet speed controls.

In the illustrated embodiment, the occlusion mechanism is a continuous belt 62 having a width substantially equal to the length of the drum 50. The belt 62 extends around a plurality of idler rollers. In the illustrated embodiment, the belt 62 extends around a first or downstream roller 64, one or more auxiliary or idler rollers (see FIG. 1) and an upstream roller 70. In the illustrated embodiment two idler rollers (4 total rollers) are shown, however the granule applicator 22 may include more than four such rollers.

Between the upstream roller 70 and the downstream roller 64, the belt 62 also inverts concavely to engage a first portion of the outer circumferential surface 56 of drum 50. In the illustrated embodiment, the belt 62 engages a majority of the drum 50, i.e. for about 300 degrees of the outer circumferential surface 56 between the upstream roller 70 and the downstream roller 64. Therefore, a second portion of the outer circumferential surface 56 of about 60 degrees remains uncovered by the belt 62 and defines an uncovered zone 72. As shown in FIG. 5, the uncovered zone 72 must be large enough that the trajectory G of granule packets 98 released from the granule slots does not contact the downstream roller 64, or any other serial granule applicators used, but preferably is minimized to permit, and still cover, multiple circumferential openings 60 in the drum 50. Thus, the size of the uncovered zone 72 may vary based on these considerations and on the diameter of the rollers 64 and 70. As explained below, it is desirable to minimize the angle A of trajectory, so it is desirable to utilize small diameter rollers 63 and 70. In general, the angular size of the uncovered zone may range from about 30 to about 90 degrees, preferably from about 45 to about 70 degrees.

Other occlusion mechanisms are also possible and they fall generally into two main types. A first type, such as the belt described above, define an arcuate band that occludes a circumferential majority portion of the rotatable drum. An alternate embodiment comprises a C-shaped solid shell or partial tube that encases the drum but leaves an open segment uncovered where the “C” opens. In arcuate band-type occlusion mechanisms, the arcuate band position relative to the drum is fixed and the location of the open portion or uncovered segment defines the trajectory of the particles to the tacky substrate.

A second type of occlusion mechanism is defined by a door that alternates between a first, closed position and a second, open position. In door-type occlusion mechanisms there is no arcuate band, but one or more door panels cooperate to close off the opening. Doors may be hinged on one or both sides of the opening, or they may be sliding to one or both sides of the opening, or shutter-like. An opening device is timed to open the door and release the particles for a predetermined trajectory to the tacky substrate. Door opening devices may be mechanical and include components such as cams, tines, springs, levers, latches, and the like; or they may be or electronic or electromagnetic and employ solenoids, magnetic closures or switches, or optical sensors in manners well known to these arts. A simple mechanical door and opening device comprises a solid door, hinged at a trailing edge and biased closed by a spring or other device. An opening arm extends radially outward from the hinge area, thus forming an angle or L structure in cross section. An adjustable striking tine extends upwards from a frame below the rotating drum, and is adjusted such that as the drum rotates past the tine, the extended opening arm strikes the tine and is folded backward against the spring to open the door. After the opening arm slips past the tine, the spring recloses the door.

With reference again to FIG. 5, longitudinally extending ribs or wall members 74 are mounted to the interior surface 54 of the body 52. The illustrated wall members 74 have a substantially L-shaped transverse section. Alternatively, the wall members 74 may have any other desired shape, such as for example a curved cross sectional shape. Radially inwardly extending portions 74A of the wall members 74 define a granule barrier. The wall members 74 may be attached to the interior surface 54 of the body 52 by any desired means, such as by welding. Alternatively, the wall members 74 may be attached to the interior surface 54 of the body 52 by fasteners, such as bolts or screws.

The illustrated drum 50 is formed from steel. Alternatively, the drum 50 may be formed from other metals and non-metals. The interior surface 54 of the drum 50 may be coated with chrome or rubber. Alternatively, the interior surface 54 of the drum 50 may be coated with any other desired material having good wear characteristics while rotating with granules tumbling in the granule application chamber 78.

Interior drum walls 76 extend radially inwardly from the interior surface 54 of the body 52 at opposite axial ends of each granule outlet opening 60, and define a granule application chamber 78 (best shown in FIG. 3) within the interior space 58 of the body. The illustrated interior drum walls 76 include a central opening 80 through which a portion of a granule dispenser 82, described below, may extend. In the illustrated embodiment of the drum 50, the central openings 80 are substantially circular in shape. Alternatively, the central openings 80 may have any other desired shape. It will be understood that the central opening will be large enough to allow the granule dispenser 82 to extend through. It will be further understood that the central opening is not required, and that the interior drum walls 76 may be sealed about the portions of the granule dispenser 82 which extend though the interior drum walls 76.

The granule applicator 22 includes means for supplying granules 86 to the granule application chamber 78. As shown schematically in FIGS. 3 and 5, the granule applicator 22 may include an auger 84 for moving granules 86 from a source of granules (not shown) to a hopper 88 within the granule application chamber 78. Alternatively, granules 86 may be moved into the hopper 88 in the granule application chamber 78 by other suitable means, such as pump, conveyor, or a gravity-feed device, such as a chute or tube (not shown).

The granules 86 may then be fed from the hopper 88 by a fluted roll 90 from which, upon rotation, the granules 86 are discharged into contact with a chute 92. The illustrated chute 92 is elongated and has a length substantially equal to the length of the granule outlet opening 60. The illustrated chute 92 is further substantially flat, although the chute may have other shapes, such as a substantially curved cross-sectional shape. The position of the chute 92 relative to the downstream roller 64 can be important so that granules do not fall from the chute directly through any openings to sheet below. Alternatively or in addition to the chute, the drum interior may include a series of baffles (not shown) that catch and direct granules to the openings 60.

In the embodiment shown, the chute 92 extends outwardly and downstream toward the interior surface 54 of the body 52 such that an end 92A of the chute 92 is spaced a distance 94 away from the interior surface 54. The distance 94 is larger than a length 96 of the radially inwardly extending portions 74A of the wall members 74, thereby providing clearance between the chute 92 and the wall members 74 as the drum 50 rotates. The chute 92 guides the granules radially outwardly and downwardly from the fluted roll 90.

It will be understood that the hopper 88 and fluted roll 90 described above are not required, and that any other desired granule dispenser may be provided within the granule application chamber 78. Examples of other suitable granule dispensers include a hopper having a slide gate, and a vibratory feeder.

In operation, the drum 50 is caused to rotate (in a counterclockwise direction when viewing FIGS. 3 through 5). Granules 86 are discharged from the granule dispenser 82 onto the chute 92 at a pre-determined rate. As the granules 86 fall from the end 92A of the chute 92, gravity and centrifugal force move the granules 86 radially outwardly toward the interior surface 54. As the drum 50 rotates, the granules 86 slide along, or fall adjacent to, the interior surface 54 and into the opening 60, supported by centripetal force provided by the belt 62 at the radially outward bottom of the opening 60. Some granules 86 may first contact the wall member 74 and then be deflected into the opening 60. As best shown in FIG. 5, the discharged granules 86 remain in the opening 60 as the drum rotates. For this reason, the size and/or rotational speed of the drum should be selected to ensure at all times a centrifugal force of at least 1 g (1 g=32 ft/sec², gravitational acceleration), preferably greater than about 1.2 g to ensure that the granules do not fall from the openings while at the top of the cycle. Centrifugal force is calculated as V_{c}²/(r*g) where V_{c} is linear speed of the drum surface in feet/sec; and r is the drum radius in feet.

The granules 86 may be metered into the granule application chamber 78. As used herein, “metered” means controlling the rate of flow of the granules 86 into the granule application chamber 78 and/or controlling the axial position of the discharged granules 86 to ensure the granules 86 are discharged substantially to fill each of the openings 60. For example, the rate of flow out of the granule dispenser 82 may be pre-calibrated and programmed to provide a desired pre-determined rate that may vary depending on the line-speed and/or the desired appearance of the shingles being formed with the apparatus 10.

As the drum 50 rotates, the opening 60 reaches the uncovered zone 72 and the belt 62 moves in a clockwise direction around the upstream lower roller 70. The belt 62 is removed from contact with the drum 50, thereby uncovering the opening 60 and removing the centripetal force. The granules 86 within the opening 60 are then released or trajected from the rotating drum 50 by centrifugal force. Upon release from the opening 60, the granules 86 retain the shape of the opening 60 and define a granule packet 98. In the embodiments illustrated herein, the openings 60, and therefore the granule packets 98 have a substantially rectangular shape for producing a “shadow line” or a patch 46 beneath tab cutouts 40. Alternatively, the openings 60, and therefore the granule packets 98 may have another desired shape.

Upon release from the opening 60, the granule packet 98 continues to move downstream in the machine direction 13 along a trajectory indicated by the line G, forming an angle A with the sheet plane (approximately horizontal) of about 25 degrees. Alternatively, the granule packet 98 may traject at any other desired angle, such as an angle within the range of from about 5 degrees to about 35 degrees. In the illustrated embodiment, the granule applicator 22 is configured such that the granule packet 98 moving along trajectory G does not hit downstream lower roller 64 or any other process equipment associated with the apparatus 10.

Further, the granule applicator 22 is capable of applying a repeating pattern of granule patches 46 having good spatial resolution at any desired speed interval in the machine direction. For example, with the illustrated granule applicator 22, granule patches 46 having a width W3 of about 1.0 inch are deposited onto the asphalt-coated sheet every 12.0 inches. It will be understood, however, that the number and spacing of granule outlet openings 60 may vary based on the diameter of the drum 50 and the speed of the asphalt-coated sheet 20, and the desired shadow drop pattern according to easily calculated parameters. The following example will illustrate.

If a shadow drop patch or shadow line is desired in regularly spaced intervals, the parameters shown in Table 1, below, are assumed (shaded in Table) or calculated (formulas in Table). For example, assuming a desired product having patches of machine-direction width (e.g. W2 in FIG. 2) of 1 inch spaced every 9 inches and a sheet speed of 500 ft/minute, one can calculate a patch application start frequency fₛ=Vₛ/S (reciprocal is timing between patch application starts). However, knowing that the line may run at variable speeds, an absolute frequency (666.67 here) is less useful than synchronization to the drum frequency. If N=4 openings pass per revolution of a drum circumference, C, moving at belt speed V_{c}, then the frequency of drum openings, f_{d}=N/C*V_{c}. For synchronization of the drum openings to the sheet patches, it is essential that the frequencies match, i.e. f_{d}=fₛ. Substituting, this means that N/C*V_{c}=Vₛ/S and, rearranging this to, V_{c}=Vₛ*(C/S*N) it is apparent that the drum speed must be held at a constant multiple of the sheet speed, the constant dictated by the drum circumference, C, number of openings, N, and the desired spacing, S.

Knowing a desired S and that only “near sheet speed” is required, one then selects N, which must be an integer, and C (C is related to D by C=πD) to ensure that corresponding centrifugal forces will exceed gravity even at the slowest potential speeds, and to allow sufficient interior room for insertion of a granule dispensing apparatus. Assuming a low-end sheet speed of 300 feet/minute, g-force remains suitable for N=4, 5 or 6, with drum diameters (D, converted to inches) of 11.46, 14.3, and 17.19, respectively. Since material constraints make continuous diameter drums unlikely, a diameter is selected near one of these, say 12 inches, where N=4. Thus, the belt speed must be maintained at C/S*N=3.142/0.75*4=1.047 times the sheet speed, or 523.66 feet/minute. Finally, granules spun out at angle A=25 degrees from a drum traveling at V⁰=523.66 feet/minute will have a horizontal component of velocity, Vₕ⁰=V⁰*cos A=519.05 feet/minute, which is “near” the assumed sheet speed of 500 feet/minute.

Rotational velocity and circumferential distance between openings may also be calculated. Also, one may calculate a time interval or “frequency” corresponding to the start-stop of a patch and correlate that to an open-close frequency to calculate a width for opening 60. However, as a practical matter this is not necessary for narrow widths for which this invention is typically employed. Additionally, irregular but repeating interval patterns may be employed, by altering the positions of the openings 60 to irregular spacing around the drum 50.

TABLE 1

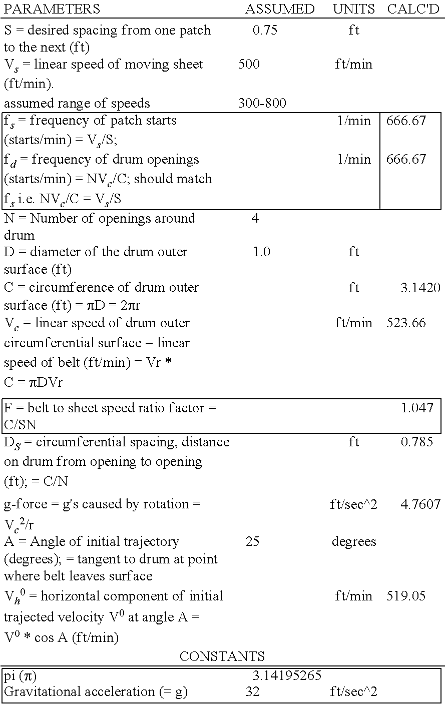

Referring now to FIG. 3, the granule applicator 22 may extend laterally, or substantially perpendicularly to the machine direction 13, across the entire width of the asphalt-coated sheet 20, and may be mounted to the apparatus 10 by any suitable means (not shown). In the embodiment illustrated in FIG. 3, the granule applicator 22 includes one granule application chamber 78 for each headlap lane H1 and H2 upon which a granule patch 46 will be deposited. Because only a portion of the asphalt-coated sheet 20 is shown, only two headlap lanes H1 and H2 are visible in FIG. 3. It will be understood that the granule applicator 22 may be constructed to include as many granule application chambers 78 as there are granule lanes upon which granule patches 46 will be deposited. A hopper, fluted roll and chute are employed for each chamber.

It will be understood that the granule applicator 22 described above may be used to deposit granule patches on the prime granule lanes P1 and P2 as well. For example, the granule applicator 22 may be configured to deposit granule patches which define shading areas, such as the vertically-oriented shading areas described in U.S. Pat. No. 6,822,637 issued to Elliott et al., which is hereby incorporated by reference in its entirety.

As an alternative to drum 50 extending across the entire width of sheet 20, the granule applicator may be formed having only one granule application chamber 78. Referring now to FIG. 6, a second embodiment of the second granule applicator is shown at 22′. The embodiment of the granule applicator 22′ includes a rotating drum 100 having a substantially cylindrical wall defining a body 102. The body 102 includes an interior surface 104 and an outer circumferential surface 106. The interior surface 104 of the body 102 defines an interior space 108. At least one granule outlet opening 110 is formed through the body 102. The drum 100 may have any desired number of granule outlet openings 110, as described above. Interior drum walls 112 are mounted to the interior surface 104 of the body 102 at opposite axial ends of the granule outlet openings 110, and define the granule application chamber 114 within the interior space 108 of the body 102. The interior drum walls 112 include a central opening 116 through which a portion of a granule dispenser may extend. The granule applicator 22′ may include any of the embodiments of the granule dispenser described above, such as the granule dispenser 82.

Each of the relatively smaller granule applicators 22′ may be positioned in staggered serial fashion such that they deposit the granule packets 98 in any one of the granule lanes of the asphalt-coated sheet 20, such as the lanes H1 and H2. If desired, a plurality of granule applicators 22′ may be connected laterally across the entire width of the asphalt-coated sheet 20. Such connected granule applicators 22′ would operate substantially the same way as drum 50.

### Accelerator Blend Drop Applicator

Whether in combination with or independent from the centrifugal shadow drop applicator described above, the invention further comprises an alternate type of granule drop applicator, as shown schematically in FIGS. 1 and 7 which operates on different principles. This type of granule drop applicator is better adapted for depositing blend drops as defined above. The blend drop applicator 122 includes a blend drop conveyor 123 having a belt 162 with an upper flight 161 and a lower flight 163. The belt 162 travels around a downstream roller 164 and an upstream roller 170 which separate the upper flight 161 and the lower flight 163. A moving surface, typically a third roller, deflects the upper flight 161 as described below. The blend drop conveyor is operated by a motor (not shown) at approximately the speed of the moving asphalt-coated sheet 20, as is described in more detail later.

In the illustrated embodiment, the upstream roller 170 is mounted higher and upstream (to the left when viewing FIG. 7) of the downstream roller 164. A third roller 166, is a moving surface positioned outside the belt 162 intermediate the upstream and downstream rollers 164 and 170 such that it deflects the upper flight 161 toward the lower flight 163 to create a concavity in the belt 162 and dividing it into three portions. A first portion of the upper flight 161 between upstream roller 170 and third roller 166 defines planar path G1; a second portion of the upper flight 161 between third roller 166 and downstream roller 164 defines planar path G2, which is not parallel to G1 and thus planes G1 and G2 intersect with angle A3; and a third portion of the upper flight 161 connects the first and second planar portions and defines an arc-shaped area of contact 171 between the upper flight 161 and the outer circumferential surface 168 of the third roller 166. The planar path G1 of the upper flight 161 is oriented at an angle A0 from a plane VP, which is substantially vertical and substantially perpendicular to the asphalt-coated sheet 20. The belt planar path G2 is oriented at an angle A2 from a plane HP, which is substantially horizontal and parallel to the asphalt-coated sheet 20. The point where the planar path G1 meets the third roller 166 defines a nip 177, discussed below.

It should be appreciated that other moving surfaces may be used in place of the third roller 166. A “moving surface” as used herein must generally fulfill two functions: (1) to deflect the upper flight into the first and second portions to change the angle of the trajectory; and (2) to rotate or move at about the same speed as the belt 162 to assist in accelerating (or decelerating) the particles to match the conveyor speed. An alternate “moving surface” comprises one end of a second conveyor belt. Other “moving surfaces” meeting these criteria may be employed.

In the embodiment illustrated in FIG. 7, the third portion of upper flight 161 has an arcuate area of contact 171 with the moving surface or third roller 166 with an included angle of contact A1 of about 55 degrees. The importance and relevance of this included angle A1, and the planar angles A0, A2 and A3 will be discussed momentarily.

Positioned above the upper flight 161 is a granule dispenser 182, shown in cross section. The illustrated granule dispenser 182 includes a hopper 188 and a mechanism, generally indicated at 185 for metering and delivering granules 186 from the hopper 188 to the blend drop conveyor 123 to form metered blend drops 146. The mechanism 185 for metering and delivering granules 186 includes a movable gate 189 for opening and closing a discharge slot 191 of the hopper 188, and a chute 192 for directing the metered blend drops 146 to the blend drop conveyor 123. Such a granule dispenser 182 is disclosed in more detail in U.S. Pat. Nos. 6,610,147 and 7,163,716 to Aschenbeck, which are hereby incorporated by reference in their entirety.

Alternatively, other granule dispensers may be used, including granule dispensers in which granules are fed from a hopper by means of a fluted roll from which, upon rotation, the granules are discharged onto the asphalt-coated sheet. Auger-based or gravity-fed means may be employed to feed the hoppers. It will be understood that the rate of flow of the granules from the hopper 188 to the nip 177 may be metered and programmed to provide a desired pre-determined granule flow rate, a predetermined frequency or periodicity of operation, or both, each which may vary depending on the line-speed and/or the desired appearance of the shingles being formed.

As shown in FIG. 7, blend drops 145 are dispensed from the hopper 188 to chute 192, which directs the metered blend drops 145 to the first portion of the upper flight 161 of the blend drop conveyor 123. Specifically, the chute 192 directs the blend drops 145 to the nip 177. As the granules travel between the discharge slot 191 and the nip 177, they achieve a first speed by the time they reach the nip 177. It will be understood that the first speed of the metered blend drop 145 will depend primarily on gravity and the time interval of travel from the discharge slot 191 to the nip 177, but also to some extent on the surface material and angle of the chute 192, and whether or not they contact upper flight 161 prior to reaching the nip 177.

As the blend drop 145 reaches the nip 177, the granules are fixed or trapped between the upper flight 161 and the third roller 166 by friction as tension in the belt 162 urges the upper flight 161 into contact with the third roller 166. The purpose of the arc-shaped area of contact between the upper flight 161 and moving surface or third roller 166 is two-fold. First, it alters the path of the metered blend drops 145 from the more vertical path within angle A0 to the path G2 which affords a more acute angle of impact with the moving sheet as discussed below. Second, it controls the speed of travel of the granules of blend drops 145. As mentioned, the first speed is governed primarily by gravity, while a second speed is governed by the belt speed which, in turn, is adjusted to achieve the near sheet-speed as described below. At high line speeds, the blend drop 145 is typically accelerated but at low line speeds it may be decelerated. Thus, while the second speed may be greater than, equal to or less than the first speed, the subsequent discussion will generally assume an acceleration of the granules, which is the case for desired high line speeds.

Standard specifications for roofing granules allow for about a 4-5 fold variation in size. While about 90% may fall between 0.067 and 0.017 inches (screen test), the extremes of the size distribution contain even larger and smaller granules. Larger particles tend to be frictionally engaged and brought to belt speed more quickly than smaller particles which, due to gaps created by larger particles, are more easily able to resist frictional forces in favor of inertial forces. The blend drop 145 should maintain contact with the upper flight 161 for sufficient time to get substantially all the granules accelerated to the belt speed, and this is ensured by the moving surface or third roller 166. At a given belt speed, the time for blend drops to contact and frictionally engaged the belt is governed by the included angle of contact, A1. In the embodiment illustrated in FIG. 7, the angle A1 is about 55 degrees, although will be appreciated that this area of contact may be less than 55 degrees, such as when less contact time is sufficient, e.g. with particle having more uniform size distributions; or greater than 55 degrees in the case when more contact time is required, as may be the case with more diverse particle size distributions. Angle A1 may range, for example, from about 35 to about 90 degrees; or about 45 to about 80; more preferably from about 55 to about 70 degrees.

As the particles or granules of blend drop 145 emerge from the contact area 171, they separate from the third roller 166 and continue to travel on the upper flight 161 along the altered path G2. As the belt 162 turns around the downstream roller 164, the granules of blend drop 145 are released from contact with the belt 162 and trajected along a third path generally shown by the trajectory line G3. At slower belt speeds however, due to the relatively greater impact of gravity over a longer travel time, the blend drop 145 may travel along a shorter path to the asphalt-coated sheet 20, such as indicated by the trajectory G3′. The blend drop 146 is shown applied to the moving sheet 20.

It will be understood that the upstream roller 170 may have any desired position relative to the downstream roller 164, and there is no criticality to the angle between the sheet 20 and the plane formed by the axes of rotation of the rollers 164, 170. Rather, in operation, downstream roller 164 is first positioned along the manufacturing line; then third roller 166 is positioned so as to create a desired angle A2 represented by path G2 (or trajectory G3) and the sheet plane; and finally, the position of upstream roller 170 is selected to provide the desired contact area 171 and included angle A1. While angle A2 is important, the precise angle A0 between path G1 and vertical plane VP is not critical. In the illustrated embodiment, the angle A0 is about 20 degrees, but it could easily range of from about −25 degrees to about 35 degrees, subject only to practical roller diameters and distances. Preferably, angle A0 may be within the range of from about 5 degrees to about 25 degrees.

FIG. 4 shows portion of an asphalt-coated sheet 20 to which granule blend drops 146 have been applied using a blend drop applicator as described above. As shown, the asphalt-coated sheet 20 may be used in an apparatus 10 for forming multiple shingles. For example, the asphalt-coated sheet 20 may be used in an apparatus 10 for forming a plurality of shingles, such as two, three, or four shingles. In a four-wide apparatus, the asphalt-coated sheet 20 may include eight different lanes, however only four lanes are illustrated. In the embodiment of the asphalt-coated sheet 20 illustrated in FIG. 4, two headlap granule lanes H1 and H2, and two prime granule lanes P1 and P2 are shown, an imaginary line 132 separates the headlap portions from the prime portions.

Advantageously, the blend drop applicator 122 may allow any pattern of blend drops 146, such as a semi-random pattern of FIG. 4, to be applied on an asphalt-coated sheet 20 moving at machine speed, wherein the blend drops have good spatial resolution at any desired machine or sheet-speed. In particular, this means that spatial resolution is essentially the same quality at any practical sheet speed (e.g. 300 to about 1000 feet/minute) and even when one speed is up to 2-3 times the other speed. The length (in machine direction) of a blend drop 146 is controlled by the length of time the hopper gate remains open; blend drop width and density are controlled by the size of the hopper slot opening; and the spacing between blend drops 146 is governed by the time interval from hopper gate closing to next opening.

### Common Features

In each of the embodiments discussed above, the granules or granule packets are trajected at an angle A (or A2 in the embodiment of FIG. 7) relative to the plane of the sheet 20 (typically horizontal) with an initial velocity V⁰ that is equal to the speed of the belt 62, 162. This initial velocity V⁰ is resolvable into a horizontal component vector, Vₕ⁰=V⁰*cos A; and a vertical vector Vᵥ⁰=V⁰*sin A.

Over time, gravity slightly alters the vertical vector such that velocity at any time interval t (beginning when the particles leave the supporting belt), Vᵥ^{t}, equals Vᵥ^{t}+g*t (where g=gravitational force=32 ft/sec² or 9.80 m/sec²). In contrast, practically no other forces act on the horizontal component, which remains essentially equal to Vₕ⁰ over time. In order to minimize granule bounce that leads to poorly defined spatial resolution and edge definition, it is important that the granules be deposited with a target initial velocity V_{T} such that the horizontal component Vₕ is approximately equal to the speed of the substrate sheet 20 passing below (sheet speed or line speed). While the ideal target initial velocity is thus known, as a practical matter, approximating this with a “near sheet speed” is generally sufficient. “Near sheet speed” as used herein means a velocity such that the horizontal component is within the range of about +/−200 feet/minute from the sheet-speed; preferably within +/−100 feet/minute from the sheet-speed; more preferably within +/−50 feet/minute from the sheet-speed; or even within +/−25 feet/minute from the sheet-speed.

As the granule packets 98 and blend drops 145 leave the granule applicators 22, 122 they continue forward along the air trajectories G, G3 and impact the asphalt-coated sheet 20 at a glancing angle. The initial trajectories are represented in the Figures as A and A2; ignoring the effect of gravity, the impact angle is essentially the alternate interior angle and is equal to A, A2. Although the substrate is tacky, not all granules land on a tacky area; some may land on other granules or harder surfaces and they tend to deflect or bounce. A small angle of impact is limited by roller diameters and presence of additional roller from the same or serial applicators. The angle of impact is acute, preferably from 5 to 35 degrees, more preferably from about 15 to about 30 degrees.

The vertical component of velocity at time of impact equals the sum of the initial vertical velocity and the velocity caused by gravitational acceleration over the time interval to impact (Vᵥ^{t}, equals Vᵥ⁰+g*t), so minimizing the angle of impact diminishes the initial vertical aspect, thereby softening the vertical velocity at impact to that which only gravity mandates. Without intending to be limited to any particular theory, it is believed that this reduces the deflection and bouncing of granules on the surface and contributes to a pattern of granule drops (such as patches 46, and blend drops 146) on an asphalt-coated sheet 20 moving at machine speed, wherein the granule drops have good spatial resolution at any desired line or machine speed.

Moreover, maintaining the speed of the belt 62, 162 at “near sheet speed” as described above also tends to improve the spatial resolution. Granule packets 98 released from openings 60 or blend drops 145 released from roller 164 are traveling with a horizontal component of velocity that is near zero relative to the sheet 20 moving beneath them. Upon impact, the granules tend to settle into position with little scattering and bouncing and, even when bouncing, they tend to bounce at sheet speed, thereby not scattering beyond the target area and improving spatial resolution.

The need to dispense granules with a target velocity meeting these tolerance ranges is particularly challenging at high sheet speeds and when the sheets slow or speed up for any reason, as can frequently occur in the manufacture of shingles. The belt speed can be adjusted accordingly to maintain this target “near sheet speed” velocity. Perhaps even more important is a synchronization of granule drops with the desired distances or lengths on a sheet. For example, if granule drops are required in regular periodic patterns, such as every 12 inches to correspond with tab cutouts that are made every 12 inches, the period from commencing release to commencing the next release is a critical period. The timing of the release of batches of granules from the belt must be synchronized closely with the sheet speed, using formulas discussed above. For this purpose, a feedback mechanism and computerized controls (not shown) may be used to link the controls of line drive motors and belt drive motors.

The principle and mode of operation of the granule applicator have been described in its preferred embodiment. However, it should be noted that the granule applicator described herein may be practiced otherwise than as specifically illustrated and described without departing from its scope.

What is claimed is:

1. An apparatus for applying particles onto a sheet of tacky substrate moving in a machine direction at a sheet speed, the apparatus comprising:
a rotatable member having an axis of rotation and an annular body wall defining an outer circumferential surface, at least one interior space and an exterior, the body wall having at least one circumferential opening connecting the interior space with the exterior;
a particle dispenser mounted within the interior space of the rotating member and connected to a source of particles and adapted to dispense particles into the interior space; and
an occlusion mechanism cooperating with said rotating member for occluding said circumferential opening when the circumferential opening is rotated to at least one first position, and when the circumferential opening is rotated to a second position, said occlusion mechanism uncovers the opening; and
wherein the apparatus is disposed relative to the moving sheet of tacky substrate such that, upon rotation, when the circumferential opening rotates to the second, uncovered position the particles escape the interior via the opening and are trajected onto the tacky substrate.

2. The apparatus according to claim 1, wherein said occlusion mechanism comprises an arcuate band forming a cylindrical cover around a majority of the outer circumferential surface of said rotatable member but leaving an axially aligned segment uncovered such that the circumferential opening is at its first position when covered by said arcuate band and is at its second position when rotated to the uncovered segment.

3. The apparatus according to claim 2, wherein said arcuate band comprises a movable belt disposed around a majority of the outer circumferential surface of said rotatable member but directed away from said surface to leave an uncovered segment.

4. The apparatus according to claim 2, wherein the arcuate band leaves an uncovered segment comprising from about 45 to about 70 degrees of the outer circumferential surface.

5. The apparatus according to claim 1, wherein said occlusion mechanism comprises a door for sealing said circumferential opening while in its first position and an opening device for opening said door when the circumferential opening is rotated to its second position.

6. The apparatus according to claim 1, wherein the body wall further comprises radially inwardly directed ribs extending axially adjacent each opening, for catching and deflecting particles into the opening.

7. The apparatus according to claim 1, wherein the rotatable member further includes at least one radial wall extending from the annular body wall radially inward to divide the interior space into two or more axial chambers.

8. The apparatus according to claim 7, wherein the particle dispenser includes an auger to distribute particles to each of the two or more axial chambers.

9. The apparatus according to claim 1, wherein the body wall has at least 3 circumferential openings distributed about its circumference, and the openings are generally rectangular having a long axis aligned axially with the body wall and a short axis aligned circumferentially with the body wall.

10. A granule applicator for applying granules onto an asphalt-coated sheet moving in a machine direction, the granule applicator comprising:
a rotatable member having an axis of rotation and an annular body wall defining an outer circumferential surface, at least one interior space and an exterior, the body wall having at least one circumferential opening connecting the interior space with the exterior;
a granule dispenser mounted within the interior space of the rotating member and connected to a source of granules and adapted to dispense granules into the interior space; and
a movable belt disposed around a majority of the outer circumferential surface of said rotatable member and occluding said circumferential opening when the circumferential opening is rotated to at least one first position covered by said belt, and uncovering the circumferential opening when it is rotated to a second position; and
wherein the apparatus is disposed relative to the moving asphalt-coated sheet such that, upon rotation, when the circumferential opening rotates to the second, uncovered position the granules escape the interior via the opening and are trajected onto the asphalt-coated sheet.

11. The apparatus according to claim 10, wherein the belt leaves an uncovered segment comprising from about 45 to about 70 degrees of the outer circumferential surface.

12. The apparatus according to claim 10, wherein the rotatable member further includes at least one radial wall extending from the annular body wall radially inward to divide the interior space into two or more axial chambers.

13. The apparatus according to claim 10, wherein the granule dispenser includes an auger to distribute granules to each of the two or more axial chambers.

14. The apparatus according to claim 10, wherein the body wall has at least 3 circumferential openings distributed about its circumference, and the openings are generally rectangular having a long axis aligned axially with the body wall and a short axis aligned circumferentially with the body wall.

15. A method of applying particles onto a sheet of tacky substrate using the apparatus of claim 1, the method comprising:
positioning said apparatus above a sheet of tacky substrate;
introducing particles into the interior space of the rotatable member,
rotating the rotatable member to move said circumferential opening from its first, closed position to its second, open position at a speed sufficient to traject said particles onto the moving tacky substrate.

16. The method according to claim 15, wherein the particles are trajected onto the moving tacky substrate substantially in the shape of the opening.

17. The method according to claim 15, wherein the particles are trajected at near sheet speed relative to the moving sheet of tacky substrate.

18. The method according to claim 17, wherein the particles are trajected at low angle of trajectory relative to the moving sheet.

19. The method according to claim 15, wherein said occlusion mechanism comprises a movable belt disposed around a majority of the outer circumferential surface of said rotatable member but directed away from said surface to leave an uncovered segment.

20. The method according to claim 19, wherein the uncovered segment of the rotating member comprises from about 45 to about 70 degrees of the outer circumferential surface.

21. The method according to claim 15, wherein the moving sheet of tacky substrate is an asphalt-coated sheet and the particles are granules.

22. The method according to claim 21, wherein upon release from the opening, the granules assume the shape of the opening and define a granule packet, the method further comprising releasing the granule packet in the machine direction at a speed substantially equal to a sheet speed of the asphalt-coated sheet; and wherein the granule packet contacts the asphalt-coated sheet to form a granule patch that maintains substantially the same shape that the granule packet had upon release of the granule packet from the opening; and wherein the definition of edges of the granule packet is retained, and wherein minimal distortion of the shape of the granule packet occurs between release from the opening and contact with the asphalt-coated sheet.

23. The method according to claim 21, wherein the body wall has at least 3 circumferential openings distributed about its circumference, and the openings are generally rectangular having a long axis aligned axially with the body wall and a short axis aligned circumferentially with the body wall; and wherein the method further comprises depositing regular, repeating rectangularly shaped patches of granules on the asphalt-coated sheet.
